(19) United States
(12) Patent Application Publication
(10) Pub. No.: US 2019/0135670 A1
(43) Pub. Date: May 9, 2019

(54) WASTEWATER TREATMENT PLANT AND METHOD FOR TREATING WASTEWATER

(71) Applicant: HUBER SE, BERCHING (DE)

(72) Inventors: CHRISTIAN FROMMANN, NEUMARKT (DE); MICHAEL KINK, NEUMARKT (DE)

(21) Appl. No.: 16/168,065

(22) Filed: Oct. 23, 2018

(30) Foreign Application Priority Data
Nov. 9, 2017 (DE) 10 2017 126 251.2

(51) Int. Cl. C02F 9/00; B01D 29/03; B01D 24/02; B01D 33/06; B01D 29/94; B01D 33/48

(52) U.S. Cl. CPC C02F 9/00; B01D 29/03; B01D 24/02; C02F 3/12; B01D 29/94; B01D 33/48; B01D 2029/033; B01D 33/06

(57) ABSTRACT

A method for treating wastewater in a wastewater treatment plant includes passing the wastewater passes through a rake system and, thereafter, a sand trap to separate from the wastewater, solids having different particle sizes. A screening device screens the wastewater emerging from the sand trap to yield a primary sludge that fails to pass through the screening device and a suspension passing through the screening device. The suspension is fed to at least one further treatment stage, and the primary sludge is thickened with the aid of at least one thickener. The thickened primary sludge is fed to one or several further treatment stages. Moreover, a wastewater treatment plant for treating wastewater is described.

The present invention relates to a method for treating wastewater and to a wastewater treatment plant.

Wastewater treatment plants are sufficiently known from the related art and are utilized for removing contaminants from private and municipal wastewater. Conventional wastewater treatment plants generally include several treatment stages in order to remove the contaminants, which can be solids or even microorganisms, from the wastewater.

After passing through a screening device and a sand trap, the wastewater is mostly fed to a so-called primary tank, in which settleable solids settle due to the slow flow speed of the wastewater within the primary tank, or floating solids float. The wastewater, which has been partially freed of the settleable and the floating solids, finally enters a biological treatment stage, in the form of an activated sludge tank, for example, in which certain matter still present in the wastewater is decomposed with the aid of microorganisms (bacteria and yeast).

The problem addressed by the present invention is that of accelerating the previously known method for wastewater treatment and of providing a wastewater treatment plant, with the aid of which the method can be implemented.

The problem is solved using a method and a wastewater treatment plant including the features of the independent patent claims.

According to the invention, the method provides, as is known from the related art, that the wastewater to be treated initially passes through a rake system and, thereafter, a sand trap. With the aid of the screen, coarse contaminants such as stones, as well as leaves and branches or animal carcasses, are retained and, therefore, removed from the wastewater, in order to prevent these types of contaminants from clogging the pumps of the wastewater treatment plant and adversely affecting the biological cleaning result in the biological treatment stage described in the following. In general, fine screens having a bar spacing of a few millimeters and coarse screens having a bar spacing of one to several centimeters are known in this connection, wherein both types of screens can be utilized in this case.

At this point, it is pointed out that the term “wastewater” is repeatedly utilized in the following. In this case, the wastewater is always a mixture of water and contaminants, wherein the type, size, and number of contaminants changes in the course of the treatment of the wastewater due to separation or conversion of a portion of the contaminants. The wastewater which, for example, emerges from the screening device described in the following, therefore has a different level of contamination than the wastewater which enters the rake system or is conveyed from the static thickener, which is also described in the following, into a biological treatment stage, for example, an activated sludge tank.

In the next step, the wastewater, which has been freed of coarse solids, enters a sand trap, preferably via a direct path. In the sand trap, which is preferably designed as a settling tank, settleable solids such as sand, small stones, or glass chips are removed from the wastewater in order to prevent this matter from causing disruptions in the plant in a subsequent treatment stage (e.g., in the form of wear or obstructions).

The core of the invention is that the wastewater emerging from the sand trap is screened with the aid of a screening device. This yields a fraction referred to in the following as primary sludge and a suspension passing through the screening device. The aforementioned suspension is wastewater comprising solids which have not been retained by the screen surface of the screening device. On the other hand, the primary sludge comprises the solids retained by the screen surface as well as a portion of the water fraction of the wastewater that remains adhered to the solids separated out via screening. As provided in one advantageous refinement, if the filter device comprises spray nozzles, with the aid of which cleaning fluid is sprayed onto the screen surface in order to remove retained solids, the primary sludge can also include a portion of the cleaning fluid or all of the sprayed-on cleaning fluid which, together with the solids, is collected and discharged from the screening device.

The screening device is preferably a filter drum comprising a cylindrical screen surface which can be set into a rotary motion with the aid of a drive. Flow takes place through the screen surface, for example, from the inside to the outside, and so retained solids collect in the interior and, from there, can be discharged from the screening device. It is also conceivable to utilize other screening devices, such as a disk-type filter comprising several rotatably mounted filter disks which form a cavity. The wastewater flows through the filter disks from the inside to the outside or from the outside to the inside relative to the cavity formed by the filter disks, wherein contaminants of up to a certain particle size are retained by the screen surface of the disk-type filter.

The aforementioned suspension is fed to at least one further treatment stage, wherein this can be a biological treatment stage described in greater detail further below, for example, an activated sludge tank.

The aforementioned primary sludge is also fed to one further treatment stage in the form of a thickener and, there, is thickened, i.e., its solid content is increased. In general, the thickener is a device in which two fractions having a different solid content form, wherein the fraction having the greater solid content is referred to in the following as the thickened primary sludge. The thickened primary sludge, after emerging from the thickener, is fed to one or several further treatment stages, wherein possible treatment stages, such as a digester, are described in the following.

In particular, it is advantageous when the primary sludge is thickened with the aid of a static thickener. A static thickener is an accommodating device such as a trough or a tank, in which the primary sludge coming from the screening device is intermediately stored for a while. Due to the storage, settleable solids settle. If the upper sludge layer in the static thickener, which has a lower solid content than the lower sludge layer, is now discharged from the static thickener, a primary sludge fraction remains within the static thickener, which has a higher solid content than the primary sludge emerging from the screening device. The static thickener is therefore utilized for increasing the solid content of the primary sludge by way of wastewater being withdrawn from the static thickener, which has a lower solid content than the primary sludge originating from the screening device.

In particular, it is advantageous when the residence time of the primary sludge in the static thickener is between 1 h and 10 h, preferably between 2 h and 8 h. The time is sufficient for achieving the desired thickening, without the overall treatment of the wastewater being excessively delayed. In this case, it is further advantageous when the primary sludge, after having been introduced into the static thickener, is moved by the static thickener during its residence time. In other words, it is therefore advantageous when new primary sludge originating from the screening device is constantly introduced into the static thickener and thickened primary sludge is constantly withdrawn from the static thickener. As a result, a continuous operation of the static thickener and of the screening device is possible.

It is also advantageous when the primary sludge thickened with the aid of the static thickener, after emerging from the static thickener, is fed to a mechanical thickener and, there, is further thickened. A disk thickener (comprising a slowly rotating filter disk, with the aid of which fluid is separated from the primary sludge) known from the related art, a belt thickener (comprising a moving filter belt, with the aid of which liquid is separated from the primary sludge), a drum thickener (comprising a slowly rotating filter drum, with the aid of which liquid is separated from the primary sludge), a rotary screw thickener (comprising a conveying screw rotating within a filter basket, with the aid of which liquid is separated from the primary sludge pressed against the screen basket) or even a centrifuge can be utilized as the mechanical thickener. The feature common to all mechanical thickeners is that liquid (which can even still comprise a certain solid content) is separated, in a mechanical way, from the thickened primary sludge coming from the static thickener, wherein the solid content of the thickened primary sludge further increases as a result.

It is particularly advantageous when the thickened primary sludge emerging from the static thickener or the thickened primary sludge emerging from the mechanical thickener is fed to a unit for the sludge stabilization of the primary sludge. The sludge stabilization is understood to be the mineralization of the organic substance in the thickened primary sludge and, as a result, its chemical-biological “stabilization”. The goal of the stabilization is that, afterwards, biological or chemical conversion processes proceed only in a limited manner or very slowly, so that a utilization of wastewater sludge can take place. Sludge stabilization can take place aerobically or anaerobically, but also chemically, for example, via wet oxidation or chemically-physically with the aid of calcium oxide (quicklime) or thermally via incineration. Preferably, the stabilization takes place, within the scope of the invention, with the aid of a digester known, in principle, from the related art, which can be present, for example, in the form of a digestion tower.

It is particularly advantageous when the wastewater in the screening device is screened with the aid of a screen surface, the mesh size of which is between 1 μm and 10 mm. This yields a suspension which passed through the screen surface and the remaining solids of which have a very small particle size. The suspension can therefore be easily fed to a downstream biological cleaning stage which, for example, includes a biological treatment stage, in particular, an activated sludge tank. Preferably, the mesh size is between 5 μm and 5 mm and, very particularly preferably, between 10 μm and 1 mm, and so even minute particles can be separated from the wastewater. Finally, the solids which have been separated out via screening can be fed, as a portion of the primary sludge separated from the wastewater, to the aforementioned static thickener or directly to a mechanical thickener.

It is also advantageous when the solids retained by the screen surface are removed from the screen surface continuously or at intervals with the aid of a cleaning fluid. The cleaning fluid is sprayed onto the screen surface, for example, with the aid of one or several spray nozzles, in a direction which is opposite the direction in which the wastewater passes through the screen surface. Finally, the sprayed liquid and the solids removed from the screen surface can be collected via a discharge outlet of the screening device and can be discharged from the screening device. The discharge outlet includes, for example, a cone collector, with the aid of which solids dropping from the screen surface as well as cleaning fluid dripping downward can be collected. The discharge outlet can also comprise a conveying unit, for example, a conveying screw, with the aid of which the collected solids and the collected cleaning fluid or a portion thereof can be discharged from the screening device. The screen surface is therefore preferably cleaned in the countercurrent. In the end, the primary sludge emerging from the screening device comprises liquid from the wastewater which is carried along by the solids which have been separated out via screening, and at least a portion of the sprayed cleaning fluid and the solids retained by the screen surface.

Additionally or alternatively, it is also conceivable that the screen surface is cleaned by an air flow, for example, a so-called air blade. In this case, easily compressed air is directed onto the screen surface in order to clean the screen surface of the contaminants separated out by the screen surface. For example, it is possible to apply an air flow generated by a fan onto the screen surface at high speed in order to clean the screen surface.

In this case, the primary sludge emerging from the screening device is in the form of the contaminants from the wastewater flowing into the screening device, which were retained by the screen surface and were removed therefrom with the aid of the air flow, wherein a portion of the liquid of the wastewater can adhere to the contaminants. As compared to the utilization of a cleaning fluid, this has the advantage that the primary sludge can be subsequently more easily thickened, since no additional cleaning fluid is introduced into the method for the cleaning.

The cleaning of the screen surface of the screening device therefore takes place, in general, with the aid of a cleaning fluid, wherein this cleaning fluid can be in the form of a cleaning liquid, for example, water, or as a gas, preferably air. A mixture of the two is also conceivable.

It is particularly advantageous when the primary sludge emerging from the screening device has a solid content per unit mass (=dry substance) of 0.01% to 10%, preferably of 0.1% to 5%, particularly preferably of 0.2% to 3.5%. The primary sludge is still relatively fluid in this case and, therefore, can be thickened particularly well with the aid of a static or mechanical thickener.

Moreover, it is advantageous when the primary sludge emerging from the screening device is thickened with the aid of the static thickener to a solid content per unit mass of 0.1% to 15%, preferably of 1% to 10%, particularly preferably of 2% to 6%, The primary sludge emerging from the static thickener can be easily pumped, in this case, and, therefore, can be easily fed to a mechanical thickener.

It is particularly advantageous when the primary sludge emerging from the static thickener is thickened with the aid of the mechanical thickener to a solid content per unit mass of 1% to 15%, preferably of 2% to 10%, particularly preferably of 4% to 8%. Subsequent to the mechanical thickener, the primary sludge has a consistency which allows for a subsequent stabilization, in particular in a digester, for example, in the form of a digestion tower.

It is also advantageous when the suspension emerging from the screening device is fed to a biological treatment stage, for example, an activated sludge tank, and, there, is biologically clarified. In the biological treatment stage, an aerobic treatment of the wastewater takes place, i.e., organic substance is decomposed under aerobic conditions with the aid of microorganisms. Moreover, it is possible that the wastewater emerging from the biological treatment stage is fed to a secondary clarification tank and, there, undergoes secondary treatment. Here, a settling of solids and/or dead microorganisms which are still present takes place once again, wherein a fraction comprising the settled material, the so-called excess sludge, can be separated out and also fed to a stabilization.

Moreover, it is advantageous when wastewater is separated from the primary sludge during the thickening of the primary sludge in the static thickener, wherein the wastewater which has been separated out is also fed to the aforementioned biological treatment stage. Finally, the wastewater emerging from the biological treatment stage can also be fed to a secondary clarification tank in order to be further clarified there.

The wastewater treatment plant according to the present invention comprises, preferably in addition to further treatment stages or devices such as a central controller, a rake system and a sand trap installed downstream from the rake system in the flow direction of the wastewater. As described above, solids having different particle sizes are separated out of the wastewater with the aid of the rake system and the sand trap.

Moreover, the wastewater treatment plant comprises a screening device installed downstream from the sand trap in the flow direction of the wastewater, with the aid of which the wastewater emerging from the sand trap is screened. This yields, as has also been described, a primary sludge and a suspension passing through the screening device.

Furthermore, the screening device as well as the further treatment stages described in connection with the device according to the invention can have the features described above or in the detailed description of the invention.

In addition, the wastewater treatment plant includes a thickener, with the aid of which the primary sludge emerging from the screening device is thickened, wherein the thickener is preferably a static thickener.

It is also advantageous when the wastewater treatment plant includes a mechanical thickener, with the aid of which the primary sludge emerging from the static thickener is further thickened.

It is particularly advantageous when the wastewater treatment plant comprises a biological treatment stage, for example, in the form of an activated sludge tank, with the aid of which the suspension passing through the screening device is biologically clarified. The biological treatment stage can be a tank, through which wastewater flows horizontally and/or vertically.

The wastewater treatment plant can also comprise a secondary clarification tank, with the aid of which wastewater emerging from the biological treatment stage undergoes secondary treatment.

Further advantages of the invention are described in the following exemplary embodiment.

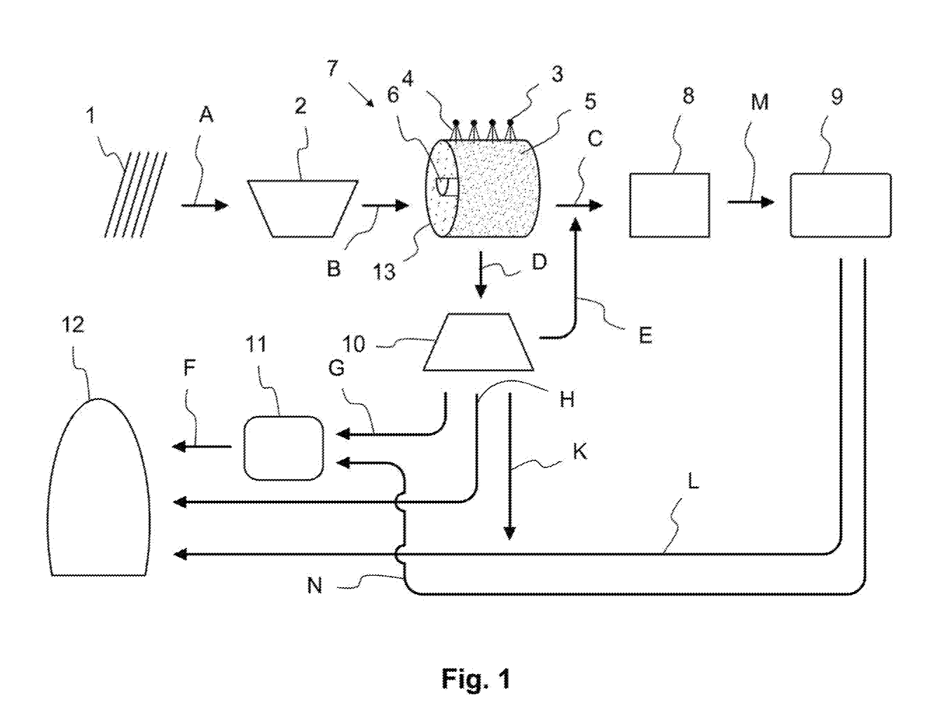

FIG. 1 schematically shows the essential treatment stages of a wastewater treatment plant according to the invention.

It is apparent from FIG. 1 that the wastewater treatment plant comprises a rake system 1, with the aid of which relatively large solids, such as stones or branches, can be separated from a wastewater flow. The rake system 1 can be, in principle, a multi-rake bar screen which comprises a bar screen and several traveling rakes, with the aid of which retained solids can be removed from the bar screen.

A sand trap 2 is installed downstream from the rake system, wherein the transport path of the wastewater emerging from the rake system 1 is marked by the arrow A.

In the sand trap 2, smaller settleable solids, such as glass chips, which have not been removed from the wastewater by the rake system 1, are at least partially separated from the wastewater.

Thereafter, the wastewater emerging from the sand trap 2 enters a screening device 7 which preferably comprises a filter drum 13 which can be set into rotary motion with the aid of a drive and which includes a screen surface 5 (the transport direction of the wastewater from the sand trap 2 to the screening device 7 is marked by the arrow B).

The wastewater flows, in this case, into the filter drum 13 via an end face. Solids which are larger than the mesh size of the filter drum 13 are retained by the screen surface 5 of the filter drum 13. One or several spray nozzles 3 is/are present in the upper area, with the aid of which cleaning fluid 4 (water, or wastewater passing through the screen surface 5) can be sprayed from the outside onto the screen surface 5. As a result, the solids adhering to the inside of the screen surface 5 are loosened and drop, together with the cleaning fluid 4, into a discharge outlet 6 situated within the filter drum 13. Alternatively or additionally, the screen surface 5 can also be cleaned with the aid of the above-described air flow.

The wastewater passing through the screen surface 5 is fed to a biological treatment stage 8 in the form of an activated sludge tank (arrow C), for example, while the primary sludge (=mixture of solids, wastewater, and cleaning fluid 4, if utilized, discharged from the screen device 7 via the discharge outlet 6) is fed to a static thickener 10 (arrow D).

There, the primary sludge is thickened by way of the separating-out of wastewater, i.e., the solid content of the primary sludge is increased. The wastewater emerging from the static thickener 10 is also fed to the biological treatment stage 8, wherein this can take place via a direct path. Alternatively, the wastewater can also be mixed with the wastewater flow between the screening device 7 and the biological treatment stage 8 (arrow E).

A further treatment of the wastewater takes place in the biological treatment stage 8. Thereafter, the wastewater is fed to a secondary clarification tank 9, as is already known from the related art (arrow M).

In the secondary clarification tank 9, a final separating-out of the so-called excess sludge takes place by gravity, wherein this excess sludge can be fed directly to a unit for stabilization (arrow L). The unit is, for example, a digester 12 which can be designed, for example, as a digestion tower.

The thickened primary sludge emerging from the static thickener 10 can also be fed to the unit for stabilization. Three alternatives are conceivable, in principle.

According to one alternative, the thickened primary sludge is introduced into the conveying line, via which the excess sludge is transported to the unit for stabilization (arrow K).

It is also conceivable that the thickened primary sludge is conveyed directly into the unit for stabilization. This option is represented by the arrow H.

Finally, it is possible that the primary sludge thickened in the static thickener 10 is initially fed to a mechanical thickener 11, as described further above, and, there, is further thickened (arrow G). The primary sludge emerging from the mechanical thickener 11 has a solid content, in this case, which is higher than the solid content of the primary sludge introduced into the mechanical thickener 11.

After emerging from the mechanical thickener 11, the additionally thickened primary sludge finally enters the unit for stabilization (arrow F).

The aforementioned alternatives can be implemented at different points in time or even simultaneously during the operation of the wastewater treatment plant. In addition, either only two of the aforementioned alternatives or only one alternative can be implemented in the specific embodiment.

Finally, it is possible that excess sludge emerging from the secondary clarification tank 9 is also fed to the mechanical thickener 11 and, there, is further thickened together with the primary sludge coming from the static thickener 10 before it is fed to the digester 12 (arrow N). The addition of chemicals (polymers) for pretreating the excess sludge emerging from the secondary clarification tank 9 between the secondary clarification tank 9 and the digester 12 can be dispensed with, in particular, in this case.

Moreover, it is conceivable that a homogenization of the two sludges can be useful in this process of the joint mechanical thickening of the primary sludge and the excess sludge. This homogenization can take place ahead of or even within the mechanical thickener 11.

In conclusion, it is pointed out, in general, that the wastewater, the primary sludge, and the excess sludge are preferably transported between the individual treatment stages with the aid of pumps and pipelines.

The present invention is not limited to the exemplary embodiment which has been represented and described. Modifications within the scope of the claims are also possible, as is any combination of the described features, even if they are represented and described in different parts of the description or the claims or in different exemplary embodiments, provided no contradiction to the teaching of the independent claims results.

### LIST OF REFERENCE SIGNS

1 rake system
2 sand trap
3 spray nozzle
4 cleaning fluid
5 screen surface
6 discharge outlet
7 screening device
8 biological treatment stage
9 secondary clarification tank
10 static thickener
11 mechanical thickener
12 digester
13 filter drum
A transport direction of the wastewater passing through the rake system
B transport direction of the wastewater passing through the sand trap
C transport direction of the suspension passing through the screening device
D transport direction of the primary sludge emerging from the screening device
E transport direction of the wastewater emerging from the static thickener
F transport direction of the thickened primary sludge emerging from the mechanical thickener
G first possible transport direction of the thickened primary sludge emerging from the static thickener
H second possible transport direction of the thickened primary sludge emerging from the static thickener
K third possible transport direction of the thickened primary sludge emerging from the static thickener
L first possible transport direction of the excess sludge emerging from the secondary clarification tank
M transport direction of the wastewater emerging from the biological treatment stage
N second possible transport direction of the excess sludge emerging from the secondary clarification tank

1. A method for treating wastewater in a wastewater treatment plant, the method comprising the steps of:
passing the wastewater through a rake system and, thereafter, a sand trap,
wherein solids having different particle sizes are separated out of the wastewater with the aid of the rake system and the sand trap,
wherein the wastewater emerging from the sand trap is screened with the aid of a screening device, wherein this yields a primary sludge and a suspension passing through the screening device,
feeding the suspension to a first further treatment stage, and
wherein the primary sludge is thickened with the aid of at least one thickener and the thickened primary sludge is fed to a second further treatment stage.

2. The method as claimed in claim 1, wherein the primary sludge is thickened with the aid of a static thickener, wherein the residence time of the primary sludge in the static thickener is between 1 h and 10 h.

3. The method as in claim 2, wherein the primary sludge thickened with the aid of the static thickener is fed to a mechanical thickener and, there, is further thickened.

4. The method as in claim 3, wherein the thickened primary sludge emerging from the static thickener or the thickened primary sludge emerging from the mechanical thickener is fed to a digester.

5. The method as claimed in claim 2, wherein the wastewater in the screening device is screened with the aid of a screen surface, the mesh size of which is between 1 μm and 10 mm, wherein the solids which have been separated out via screening are fed, as a portion of the primary sludge separated from the wastewater, to the static thickener.

6. The method as in claim 5, wherein the solids retained by the screen surface are removed from the screen surface continuously or at intervals with the aid of an air flow and/or a cleaning fluid, wherein the primary sludge emerging from the screening device comprises liquid from the wastewater which is carried along by the solids which have been separated out via screening, and, in the event that a cleaning fluid is utilized, also at least a portion of the introduced cleaning fluid.

7. The method as in claim 2, wherein the primary sludge emerging from the screening device has a solid content per unit mass of 0.01% to 10%.

8. The method as in claim 1, wherein the primary sludge emerging from the screening device is thickened with the aid of the static thickener to a solid content per unit mass of 0.1% to 15%.

9. The method as in claim 2, wherein the primary sludge emerging from the static thickener is thickened with the aid of the mechanical thickener to a solid content per unit mass of 1% to 15%.

10. The method as in claim 1, wherein the suspension emerging from the screening device is fed to a an activated sludge tank, and, there, is biologically clarified, wherein the wastewater emerging from the activated sludge tank is fed to a secondary clarification tank and, there, undergoes secondary treatment.

11. The method as in claim 2, wherein wastewater is separated from the primary sludge during the thickening of the primary sludge in the static thickener, wherein the wastewater which has been separated out is also fed to a biological treatment stage, wherein the wastewater subsequently emerging from the biological treatment stage is fed to a secondary clarification tank.

12. A wastewater treatment plant for treating wastewater, the wastewater treatment plant comprising:
a rake system and a sand trap installed downstream from the rake system in the flow direction of the wastewater, wherein solids having different particle sizes are separated out of the wastewater with the aid of the rake system and the sand trap,
a screening device installed downstream from the sand trap in the flow direction of the wastewater, with the aid of which the wastewater emerging from the sand trap is screened to yield a primary sludge, which fails to pass through the screening device, and a suspension passing through the screening device, and
a thickener, with the aid of which the primary sludge emerging from the screening device is thickened.

13. The wastewater treatment plant as in claim 12, wherein the thickener is a static thickener.

14. The wastewater treatment plant as in claim 13, further comprising a mechanical thickener configured for further thickening the primary sludge emerging from the static thickener.

15. The wastewater treatment plant as in claim 12, further comprising:
a biological treatment stage in the form of an activated sludge tank that is configured for biologically clarifying the suspension passing through the screening device, and
a secondary clarification tank that is configured for subjecting the wastewater emerging from the biological treatment stage to a secondary treatment.

16. The method as in claim 1, wherein the primary sludge is thickened with the aid of a static thickener during a residence time therein of between 2 hours and 8 hours.

17. The method as in claim 2, wherein the wastewater in the screening device is screened with the aid of a screen surface, the mesh size of which is between 10 μm and 1 mm, and further comprising the step of feeding to the static thickener the solids which have been separated out via screening as a portion of the primary sludge separated from the wastewater.

18. The method as in claim 2, wherein the primary sludge emerging from the screening device has a solid content per unit mass of 0.2% to 3.5%.

19. The method as in claim 1, wherein the primary sludge emerging from the screening device is thickened with the aid of the static thickener to a solid content per unit mass of 2% to 6%.

20. The method as in claim 2, wherein the primary sludge emerging from the static thickener is thickened with the aid of the mechanical thickener to a solid content per unit mass of 4% to 8%.
